(19) United States
(12) Patent Application Publication
(10) Pub. No.: US 2023/0397551 A1
(43) Pub. Date: Dec. 14, 2023

(54) IRRIGATION SYSTEM COMPUTING DEVICE FOR PROCESSING GEOSPATIAL DATA

(71) Applicant: Lindsay Corporation, Omaha, NE (US)

(72) Inventors: Kurtis Arlan Charling, Elkhorn, NE (US); Michael George Ricketts, Feilding, NE (US); Michael Debney, Feilding, NE (US)

(21) Appl. No.: 18/449,303

(22) Filed: Aug. 14, 2023

Related U.S. Application Data
(63) Continuation-in-part of application No. 17/062,821, filed on Oct. 5, 2020, now abandoned.

(51) Int. Cl. A01G 25/16; A01G 25/09

(52) U.S. Cl. CPC A01G 25/16; A01G 25/092

(57) ABSTRACT

A computing device for processing geospatial data associated with an irrigation system comprises a processing element in electronic communication with a memory element. The processing element is configured or programmed to receive sensor data over time from a plurality of sensors associated with the irrigation system, receive or determine geolocation data, link data from each sensor with geolocation data to form geospatial data, determine trends in the geospatial data for each sensor or a group of sensors, determine changes or adjustments in an operation of components of the irrigation system based on trends determined in the geospatial data, and output an electronic signal whose analog level or digital data value varies according to the changes or adjustments in the operation of components of the irrigation system.

### RELATED APPLICATIONS

The current patent application is a continuation-in-part patent application which claims priority benefit, with regard to all common subject matter, to U.S. patent application Ser. No. 17/062,821, entitled “IRRIGATION SYSTEM COMPUTING DEVICE FOR PROCESSING GEOSPATIAL DATA”, filed Oct. 5, 2020. The earlier-filed patent application is hereby incorporated by reference, in its entirety, into the current patent application.

### FIELD OF THE INVENTION

Embodiments of the current invention relate to computing devices for use with irrigation systems to process geospatial data.

### BACKGROUND

Irrigation systems distribute water or other fluids over an area of land to be irrigated. Center-pivot irrigation systems are ideal for use in fields having circular crop areas, while lateral-move irrigation systems are ideal for use in square, rectangular, and irregular-shaped fields. Each type of irrigation system includes a plurality of motor-driven mobile towers that support a water-carrying conduit to which a plurality of sprinklers are coupled. Each type of irrigation system may also include a plurality of sensors which monitor the performance of the irrigation system components. For example, sensors may measure pressure of the water in the conduit, water flow through the sprinklers, and other fluid related metrics. Sensors may also measure the electrical performance of the drive motors for the mobile towers. In addition, sensors may determine a geolocation, such as a latitude and longitude, of the various components of the irrigation system. Typically, data from each sensor is output as a stream of digital data samples. An irrigation system controller receives the sensor data and the geolocation data. The irrigation system controller also links the sensor data with the geolocation data such that each digital data sample for each sensor is linked with the geolocation sample for the sensor at the time when the sensor sample was taken. The linked sensor data and geolocation data is geospatial data. Traditionally, the irrigation system controller transmitted all of the geospatial data to an external computer server for processing and analysis of the geospatial data. Unfortunately, this offsite data processing complicates data flow within the irrigation system, increases transmission data payloads, delays the actions taken from processing and analysis of the geospatial data, and increases the cost of operation of the irrigation system.

### SUMMARY OF THE INVENTION

Embodiments of the current invention solve the above-mentioned problems and provide a distinct advance in the art of irrigation system data management. Specifically, embodiments of the current invention may provide an computing device and method for processing geospatial data associated with an irrigation system. These embodiments provide onsite irrigation system geospatial data analysis and processing that simplifies data flow within the irrigation system, decreases transmission data payloads, allows for rapid action to be taken from processing and analysis of the geospatial data, and decreases the cost of operation of the irrigation system.

The computing device broadly comprises a processing element in electronic communication with a memory element. The processing element is configured or programmed to receive sensor data over time from a plurality of sensors associated with the irrigation system, receive or determine geolocation data, link data from each sensor with geolocation data to form geospatial data, determine trends in the geospatial data for each sensor or a group of sensors, determine changes or adjustments in an operation of components of the irrigation system based on trends determined in the geospatial data, and output an electronic signal whose analog level or digital data value varies according to the changes or adjustments in the operation of components of the irrigation system.

The method broadly comprises the steps of receiving sensor data from a plurality of sensors; receiving or determining geolocation data; linking data from each sensor with geolocation data to form geospatial data; determining trends in the geospatial data for each sensor or a group of sensors; determining changes or adjustments in an operation of components of the irrigation system based on trends determined in the geospatial data; and outputting an electronic signal whose analog level or digital data value varies according to the changes or adjustments in the operation of components of the irrigation system.

Embodiments of the current invention also provide an irrigation system broadly comprising a conduit, a plurality of mobile towers, a plurality of valves, a pump, a plurality of sensors, and a computing device. The conduit is configured to carry fluid for irrigating crops and includes a plurality of sections coupled to one another. The mobile towers are configured to move the conduit. Each mobile tower includes a truss section configured to support the conduit and a drive motor configured to propel the mobile tower. The valves are positioned along the length of the conduit and are configured to control the flow of fluid through the conduit. The pump is configured to provide pressure of the fluid through the conduit. The sensors are configured to sense performance quantities and/or operating parameters of the drive motor of each mobile tower, the valves, and the pump. The computing device includes a processing element in electronic communication with a memory element. The processing element is configured or programmed to receive data over time from the sensors, receive or determine geolocation data, link data from each sensor with geolocation data to form geospatial data, determine trends in the geospatial data for each sensor or a group of sensors, determine changes or adjustments in an operation of the drive motor of each mobile tower, the valves, and the pump based on trends determined in the geospatial data, and output an electronic signal whose analog level or digital data value varies according to the changes or adjustments in the operation of the drive motor of each mobile tower, the valves, and the pump.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is an environmental view of an irrigation system irrigating crops, the irrigation system including, or in electronic communication with, a computing device, constructed in accordance with various embodiments of the invention, for processing geospatial data associated with the irrigation system;

FIG. 2 is a schematic block diagram of various electronic components of the computing device;

FIG. 3 is a schematic block diagram of various electronic components of the irrigation system and a computer server with which the computing device communicates; and

FIG. 4 is a listing of at least a portion of the steps of processing geospatial data associated with an irrigation system.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

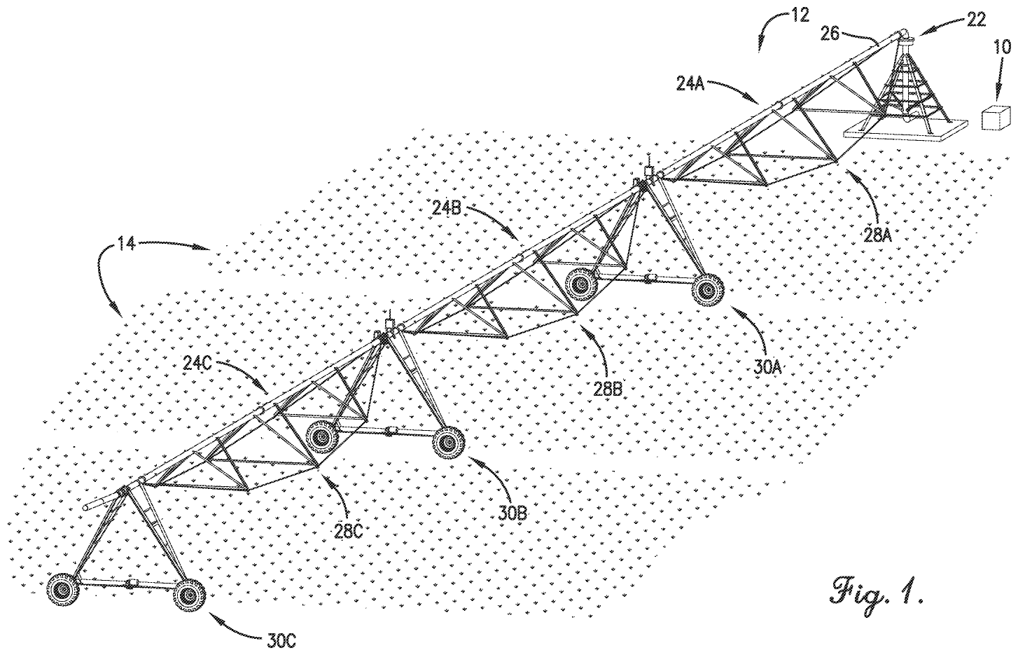

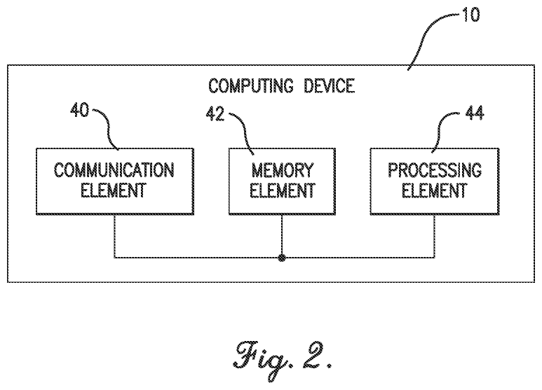

A computing device 10, constructed in accordance with various embodiments of the current invention, for processing geospatial data associated with an irrigation system 12 is shown in FIGS. 1 and 2. The irrigation system 12 is utilized to irrigate one or more crops 14 and may include a plurality of sensors 16 which collect data about components of the irrigation system 12, the crops 14, and the land that is being irrigated. The irrigation system 12 may further receive data or information from external sources about the environment surrounding the irrigation system 12. The data from the sensors 16 and the external sources is communicated to, and/or directly received by, the computing device 10. The computing device 10 may also receive, or have access to, geolocation data regarding a terrestrial location of the components of the irrigation system 12. The computing device 10 links, associates, correlates, and/or integrates the geolocation data with the sensor data to form geospatial data. The computing device 10 processes the geospatial data to determine trends or anomalies in the geospatial data. The computing device 10 may also communicate the linked data through a communication network 18 to a computer server 20 for further processing or storage.

The communication network 18 generally allows communication between the computing device 10 and the computer server 20 as well as communication between the computing device 10 and mobile electronic devices such as cell phones. The communication network 18 may include local area networks, metro area networks, wide area networks, cloud networks, the Internet, and the like, or combinations thereof. The communication network 18 may have wired architectures, wireless architectures, or combinations thereof and may include components such as switches, routers, hubs, access points, and the like. The computing device 10 and the computer server 20 may connect to the communication network 18 either through wires, such as electrical cables or fiber optic cables, or wirelessly, such as radio frequency (RF) communication using wireless standards such as Bluetooth® or the Institute of Electrical and Electronic Engineers (IEEE) 802.11.

The computer server 20 generally provides data processing and data storage and may include multiprocessor architectures, parallel processor architectures, computer clusters, and the like, which are capable of high performance computing. The computer server 20 may also include memory storage such as optical drives, hard disk drives, rack-mount drives, blade drives, and the like, as well as transceiver components that provide communication with the communication network 18.

An exemplary irrigation system 12, as shown in FIG. 1, is a central pivot irrigation system and broadly comprises a fixed central pivot 22 and a plurality of spans 24 pivotally connected to the central pivot. The irrigation system 12 may also comprise an extension arm (also commonly referred to as a “swing arm” or “corner arm”) pivotally connected to the free end of the outermost span 24. The irrigation system 12 may also be embodied by a lateral, or linear, move apparatus which irrigates while moving in a linear, or near-linear, direction without departing from the scope of the current invention.

The fixed central pivot 22 may be a tower or any other support structure about which the spans 24 pivot or rotate. The central pivot has access to a well, water tank, or other source of water and may also be coupled with a tank or other source of agricultural products to inject fertilizers, pesticides and/or other chemicals into the water for application during irrigation. The central pivot 22 may supply water to a conduit 26 or pipe which carries the water along the length of the spans 24.

The irrigation system 12 may comprise a plurality of spans 24. The exemplary irrigation system 12 shown in the figures includes three spans 24A, 24B, 24C. Each span 24 includes a truss section 28 (28A, 28B, 28C in the figures) and a mobile tower 30 (30A, 30B, 30C in the figures). The truss section 28 includes a plurality of beams rigidly connected to one another to form a framework which carries or otherwise supports the conduit 26 and other fluid distribution mechanisms that are connected in fluid communication to the conduit 26. Fluid distribution mechanisms may include sprayers, diffusers, or diffusers, each optionally attached to a drop hose, or the like. In addition, the conduit 26 may include one or more valves 32 positioned along its length which control the flow of water through the conduit 26. The opening and closing of the valves 32 may be automatically controlled with an electronic signal or digital data. In addition, the irrigation system 12 may include a plurality of pumps 34 and/or fluid pressure regulators which provide and maintain a pressure of the water through the conduit 26 and other components.

The mobile tower 30 is positioned at the outward end of the span 24 and includes at least two wheels, at least one of which is driven by a drive motor 36, wherein each wheel includes an inflatable, pressurized tire. The drive motor 36 includes an electric motor, such as an alternating current (AC) motor or a direct current (DC) motor, and may drive the wheel directly or through a drive shaft in order to propel the mobile tower 30 forward or backward. The operation of the drive motor 36 may be controlled by a variable frequency drive (VFD) motor controller. The drive motor 36 may further include, or be coupled to, a gearbox configured to transfer power from the drive motor 36 to the wheels at low speeds with high torque.

Each mobile tower 30 further includes a plurality of beams rigidly connected to one another to form a framework which couples the conduit 26 and the truss section 28 to the wheels and the drive motor 36.

The irrigation system 12 further includes a system controller 38 which controls the operation of the irrigation system 12. The system controller 38 also includes electrical and electronic components configured to interface with mechanical components of the irrigation system 12. The system controller 38 may be housed in a control panel at, or near, the central pivot 22. The system controller 38 may also be a component of, integrated with, or in electronic communication with, the computing device 10. In some embodiments, the system controller 38 and the computing device 10 may function and/or operate as a single unit.

The sensors 16 generally sense or detect performance quantities and/or operating parameters of various components of the irrigation system 12 over time. That is, each sensor 16 outputs an analog electric voltage or electric current level, which may be sampled, or a digital data sample for a series of time periods. Some sensors, including potentiometers, rotary encoders, analog proximity sensors, analog laser proximity sensors, analog ultrasonic proximity sensors, or combinations thereof, may measure a rotational angle between two adjacent mobile towers 30 or sections of the conduit 26. Water gauges, including flow meters and the like, may measure the amount of water that has been applied to the crops during a certain time period. Pressure gauges may measure the water pressure at one or more points throughout the irrigation system 12. Tire pressure sensors may sense a plurality of pressures, one pressure associated with each tire utilized in the mobile towers 30 of the irrigation system 12. Electrical sensors, or electronic sensing circuitry, may sense a plurality of electric voltages and/or electric currents, one voltage and/or current associated with each drive motor 36 of the irrigation system 12. A gearbox sensor monitors or senses a status of the gearbox coupled to the drive motor 36. The gearbox sensor may include a plurality of sensors such as a temperature sensor, a pressure sensor, a viscosity sensor, a torque sensor, or any other suitable sensor. Sensors placed on the ground or elsewhere may sense or detect water that reaches the crops 14 in order to determine water application efficiency, or the water loss between the sprayers and the crops.

The sensors 16 may include a location determining element configured to determine a current geolocation of one or more mobile towers 30 or other components of the irrigation system 12. The location determining element may receive and process radio frequency (RF) signals from a multi-constellation global navigation satellite system (GNSS) such as the global positioning system (GPS) utilized in the United States, the Galileo system utilized in Europe, the GLONASS system utilized in Russia, or the like. The location determining element may accompany or include an antenna to assist in receiving the satellite signals. The antenna may be a patch antenna, a linear antenna, or any other type of antenna that can be used with location or navigation devices. The location determining element may include satellite navigation receivers, processors, controllers, other computing devices, or combinations thereof, and memory. The location determining element may process a location electronic signal communicated from the antenna which receives the location wireless signal from one or more satellites of the GNSS. The location wireless signal includes data from which geographic information such as the current geolocation is derived. The location determining element may also receive geolocation correction or enhancement information from terrestrial reference stations utilizing real-time kinematic (RTK) standards or protocols. The current geolocation may include coordinates, such as the latitude and longitude, of the current location of components of the irrigation system 12. The geolocation may additionally, or alternatively, include data that identifies a single point, multiple points, a line, multiple lines, a polygon, or multiple polygons. The location determining element may communicate the current geolocation to the computing device 10.

The sensors 16 may include angle sensors that can detect a rotational angle between any two adjacent towers 30 and thus, provide alignment angle data of the towers 30 of the irrigation system 12. The sensors 16 may also include a plurality of switches that open or close at a particular rotational alignment angle between any two adjacent towers 30. In addition, the processing element 44 may be able to determine tower-to-tower alignment by receiving the geolocation coordinates of each tower 30 and performing mathematical computations to determine the alignment angles between the towers 30.

The sensors 16 may also sense or detect environmental quantities or conditions. For example, sensors may detect temperature, humidity, wind speed, air pressure, rain fall, available water, and the like. Alternatively, the computing device 10 may receive these values electronically from local atmospheric monitoring stations.

The sensors 16 may further include cameras capable of capturing images in the visible range, the near infrared range, the thermal infrared range, the short wave infrared range, and the like. Alternatively, the computing device 10 may receive these images electronically from satellite or other image capturing stations.

In addition, the sensors 16 may be able to determine topography or elevation of the land being irrigated as the irrigation system 12 moves across the land. Alternatively, the computing device 10 may receive topography or elevation data electronically from external sources.

Furthermore, the sensors 16 may be able to sense or determine a type of crops 14 that are being irrigated. Alternatively, the computing device 10 may receive crop information from a land manager, a farmer, or other external sources.

In various embodiments, any of the data or information discussed above may additionally, or alternatively, be derived from computer-based models.

The computing device 10 may be embodied by workstation computers, desktop computers, laptop computers, palmtop computers, notebook computers, tablets or tablet computers, smartphones, or the like. An exemplary computing device 10 may include one or more printed circuit boards, such as a motherboard, along with various peripheral devices retained in a housing to protect them from the elements. The computing device 10 may be retained in the control panel for the irrigation system 12. The computing device 10 broadly comprises a communication element 40, a memory element 42, and a processing element 44.

The communication element 40 generally allows the computing device 10 to communicate with the communication network 18 as well as other computing devices, mobile electronic devices such as cell phones, external systems, and the like. The communication element 40 may include signal and/or data transmitting and receiving circuits, such as antennas, amplifiers, filters, mixers, oscillators, digital signal processors (DSPs), and the like. The communication element 40 may establish communication wirelessly by utilizing radio frequency (RF) signals and/or data that comply with communication standards such as cellular 2G, 3G, 4G, Voice over Internet Protocol (VoIP), LTE, Voice over LTE (VoLTE), or 5G, Institute of Electrical and Electronics Engineers (IEEE) 802.11 standard such as WiFi, IEEE 802.16 standard such as WiMAX, Bluetooth™, or combinations thereof. In addition, the communication element 40 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 40 may establish communication through connectors or couplers that receive metal conductor wires or cables which are compatible with networking technologies such as ethernet. In certain embodiments, the communication element 40 may also couple with optical fiber cables. In some embodiments, the communication element 40 may be further configured to communicate with satellites. The communication element 40 may be in electronic communication with the memory element 42 and the processing element 44.

The memory element 42 may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, solid state memory, or the like, or combinations thereof. In some embodiments, the memory element 42 may be embedded in, or packaged in the same package as, the processing element 44. The memory element 42 may include, or may constitute, a non-transitory “computer-readable medium”. The memory element 42 may store the instructions, code, code statements, code segments, software, firmware, programs, applications, apps, services, daemons, or the like that are executed by the processing element 44. The memory element 42 may also store data that is received by the processing element 44 or the device in which the processing element 44 is implemented. The processing element 44 may further store data or intermediate results generated during processing, calculations, and/or computations as well as data or final results after processing, calculations, and/or computations. In addition, the memory element 42 may store settings, data, documents, sound files, photographs, movies, images, databases, and the like.

The processing element 44 may comprise one or more processors. The processing element 44 may include electronic hardware components such as microprocessors (single-core or multi-core), microcontrollers, digital signal processors (DSPs), field-programmable gate arrays (FPGAs), analog and/or digital application-specific integrated circuits (ASICs), or the like, or combinations thereof. The processing element 44 may generally execute, process, or run instructions, code, code segments, code statements, software, firmware, programs, applications, apps, processes, services, daemons, or the like. The processing element 44 may also include hardware components such as registers, finite-state machines, sequential and combinational logic, configurable logic blocks, and other electronic circuits that can perform the functions necessary for the operation of the current invention. In certain embodiments, the processing element 44 may include multiple computational components and functional blocks that are packaged separately but function as a single unit. The processing element 44 may be in electronic communication with the other electronic components through serial or parallel links that include universal busses, address busses, data busses, control lines, and the like.

The processing element 44 may be operable, configured, or programmed to perform the following functions by utilizing hardware, software, firmware, or combinations thereof. The processing element 44 receives input data, through the communication element 40, from the sensors 16 and any other data source including users, computer models, external stations, or other external sources. Each sensor 16 may output a series of digital data samples or an analog electric voltage or electric current. Analog levels may be converted by an analog to digital converter and sampled. Each sample is a data point. The processing element 44 also receives or determines geolocation data. As discussed above, a location determining sensor may communicate geolocation data to the processing element 44. In some embodiments, the irrigation system 12 may include, or be in communication with, a plurality of location determining sensors. For example, each mobile tower 30 may include a location determining sensor which communicates the geolocation of each mobile tower 30. Other components of the irrigation system 12 may include location determining sensors as well. Alternatively, or additionally, the processing element 44 may perform calculations to determine geolocation data. For example, the processing element 44 may receive sensor information about the rotation angle between two or more mobile towers 30. The processing element 44 may then perform trigonometric or other mathematical calculations to determine the geolocation of each mobile tower 30. Or, the processing element 44 may perform dead reckoning calculations, which involve receiving measured distances traveled by each mobile tower 30 or other component, to determine the geolocation of each mobile tower 30 or other components.

The processing element 44 associates, correlates, or links the geolocation data to the sensor data and/or other input data. In one scenario, the processing element 44 may receive sensor data as a series of sampled data points from each sensor 16 while at the same time, or nearly the same time, the processing element 44 may receive, or calculate, geolocation data for the particular sensor 16. The processing element 44 links the sensor data with the geolocation data such that each digital data sample for each sensor 16 is linked with the geolocation sample for the sensor 16 at the time when the sensor sample was taken. For example, the processing element 44 may receive water pressure data as a series of sampled data points from a water pressure sensor at a particular mobile tower 30, while at the same time, or nearly the same time, the processing element 44 may receive geolocation data from a location determining sensor at the particular mobile tower 30. The processing element 44 then links the water pressure reading with the geolocation data and optionally a timestamp (time of day, date) as well. The linked input (sensor) data and geolocation data, along with optional timestamp data, is one piece of geospatial data. The processing element 44 may utilize the geospatial data interchange format based on JavaScript Object Notation (GeoJSON) to represent and process geospatial data.

The processing element 44 also receives geospatial data that includes geotechnical data, such as soil materials or composition, geological formations including rock or mineral deposits, elevational information identifying plains or hills, water features including rivers, streams, or ponds, and the like. All of the geotechnical data may already be linked or associated with geolocation data. The processing element 44 may link the geotechnical data with sensor data to form geospatial data. Thus, sensor data is linked with geolocation data, such as a latitude and longitude point, line, or area, and geotechnical data, such as soil composition and/or elevation.

The processing element 44 continues to receive both input data, such as sensor data, and geolocation data as time passes and the mobile towers 30 move over the land to be irrigated. The processing element 44 also continues to link the input data and geolocation data to create geospatial data. In some embodiments, the processing element 44 communicates (through the communication element 40) the geospatial data to the computer server 20. In other embodiments, after a certain minimum amount of data has been collected, the processing element 44 analyzes the geospatial data to determine trends, patterns, and/or anomalies in the geospatial data. In some embodiments, the processing element 44 analyzes the geospatial data to determine trends, patterns, and/or anomalies after one cycle of irrigation has occurred, wherein one cycle includes one full rotation of the conduit 26 in a circular, or near circular, central pivot irrigation system 12. One cycle of irrigation may include a full pass of the conduit 26 to cover the area of a linear or lateral irrigation system 12.

The analysis may include determining increases and/or decreases in the data from each sensor 16 or group of sensors 16. The increases and/or decreases may occur over distance, area, or space and/or over time. The analysis may also include determining, computing, or calculating statistics, such as a mean or average, a moving or windowed mean or average, a median, a standard deviation, and the like, for the data from each sensor 16 or group of sensors 16. The processing element 44 may also determine when an average for a sensor 16 or group of sensors 16 is changing or if the data for a sensor 16 or group of sensors 16 has values outside of the standard deviation of the data for the sensor 16 or group of sensors 16. For example, the processing element 44 may analyze the data from one or more sensors 16 that measure water pressure in the conduit 26 or other components of the irrigation system 12. The processing element 44 may determine when the water pressure has changes, such as steady or sharp decreases or increases.

In addition, the processing element 44 determines geospatial intersections, i.e., relationships between the trends in the sensor data with geolocation data and/or geotechnical data. When the processing element 44 determines or detects a change in the data for each sensor 16 or group of sensors 16, the processing element 44 also determines if the change in sensor data has a relationship, such as a positive correlation, with the geolocation data. For example, the processing element 44 may determine if the data for each sensor 16 or group of sensors 16 repeatedly changes in the same geolocation, such as a point or, more likely, an area of the land that is being irrigated. In one instance, the processing element 44 may determine an increase in drive motor electric current every time one or more mobile towers 30 are in a particular geolocation. This scenario may be indicative of a rut or gulley in the ground that the drive motors 36 of the mobile towers 30 have to work harder to get out of.

The processing element 44 may further analyze geotechnical data to determine relationships between the trends in the sensor data with geotechnical data or geological features. For example, the processing element 44 may determine if the data for a sensor 16 or group of sensors 16 repeatedly changes at certain elevations or changes in elevations. In one instance, the processing element 44 may determine a correlation between a repeated decrease in water pressure in the conduit 26 or other components and an increase in elevation, resulting from the mobile towers 30 moving up a hill. The processing element 44 may also determine if the data for a sensor 16 or group of sensors 16 repeatedly changes for certain types of soil composition. In another instance, the processing element 44 may determine a correlation between a repeated decrease in moisture level from ground sensors and the times when the mobile towers 30 travel over ground that has a dry or rocky soil composition.

The processing element 44 utilizes artificial intelligence (AI) and/or machine learning techniques or components to analyze the geospatial data to determine trends, patterns, and/or anomalies in the geospatial data. The geospatial data, including the sensor data and its linked geolocation data, is communicated to artificial intelligence and/or machine learning hardware units or software modules which analyze the geospatial data and identify trends or patterns in the geospatial data that indicate adjustments or changes to the operation of the irrigation system 12. The processing element 44 may utilize predictive analytics, artificial neural networks, convolutional neural networks, decision trees, or the like, or combinations thereof.

The processing element 44 also determines actions to take based on the determined trends, patterns, and/or anomalies in the geospatial data. The processing element 44 adjusts or changes the operation of components of the irrigation system 12. For example, based on the determination of a decrease in water pressure in the conduit 26 when the mobile towers 30 move up a hill, the processing element 44 may determine to increase the water pressure in the conduit 26 whenever the mobile towers 30 move to the geolocation area associated with the hill. As another example, based on the determination of a decrease in moisture level in dry or rocky soil, the processing element 44 may determine to slow down the mobile towers 30 whenever the mobile towers 30 pass through the geolocation area with the dry or rocky soil. Additionally or alternatively, the processing element 44 may determine to open additional valves 32 or otherwise increase water output whenever the mobile towers 30 pass through the geolocation area with the dry or rocky soil.

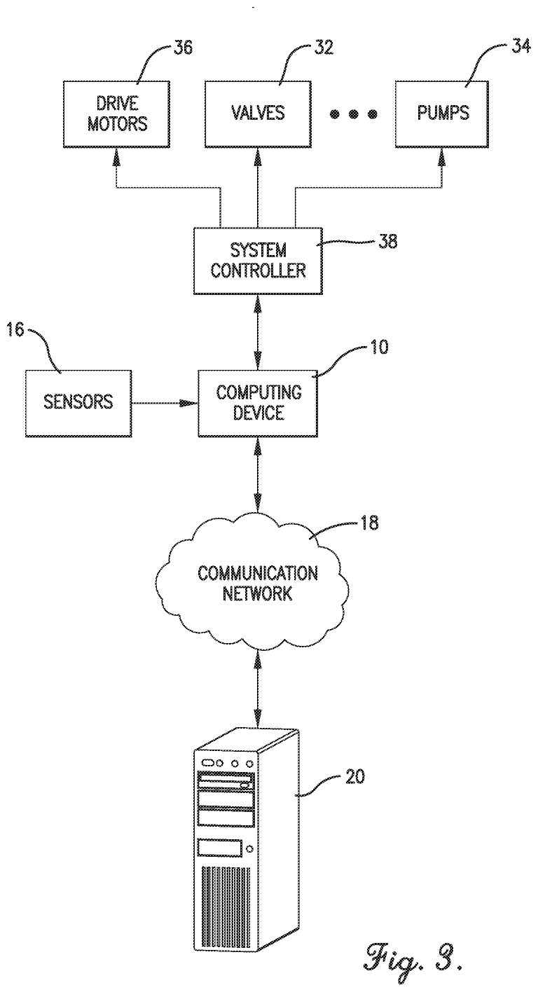

Referring to FIG. 3, the processing element 44 outputs an electronic signal, such as an analog electric voltage or electric current and/or digital data. The electronic signal may include a variable level analog electric voltage or electric current or a serial stream of variable value digital data. The electronic signal is received by the system controller 38 and includes information necessary to control the operation of the components of the irrigation system 12. The system controller 38 may output a plurality of electronic signals, each electronic signal having an analog electric voltage or electric current level and/or digital data value. Each electronic signal is received by one or more of the electrically-controlled components of the irrigation system 12 such as the drive motors 36, the valves 32, and the pumps 34.

In embodiments in which the computing device 10 and the system controller 38 function as a single unit, the processing element 44 outputs a plurality of electronic signals, each electronic signal having an analog electric voltage or electric current level and/or digital data value. Each electronic signal is received by one or more of the electrically-controlled components of the irrigation system 12 such as the drive motors 36, the valves 32, and the pumps 34.

The processing element 44 outputs the electronic signal whose analog level or digital data value varies according to changes or adjustments that need to be made in the operation of various components based on the determined trends, patterns, and/or anomalies in the geospatial data. For example, the processing element 44 outputs the electronic signal to be received by the pumps 34, either directly or through the system controller 38, wherein the analog level or digital data value of the electronic signal instructs the pumps 34 to increase the water pressure to the conduit 26 or other components when the processing element 44 determines that the mobile towers 30 are moving up a slope. As another example, the processing element 44 outputs the electronic signal to be received by the drive motors 36 (or electronic control circuitry for the drive motors 36), either directly or through the system controller 38, wherein the analog level or digital data value of the electronic signal instructs the drive motors 36 to apply more torque to the wheels of the mobile towers 30 when the processing element 44 determines that the mobile towers 30 are in a geolocation area with a rut in the ground.

The processing element 44 also communicates data, including processed geospatial data, to the computer server 20 through the communication network 18. The processing element 44 may report any trends discovered in the geospatial data as well as any changes or adjustments to the operation of the components of the irrigation system 12. The computer server 20 may store the data and/or perform further processing.

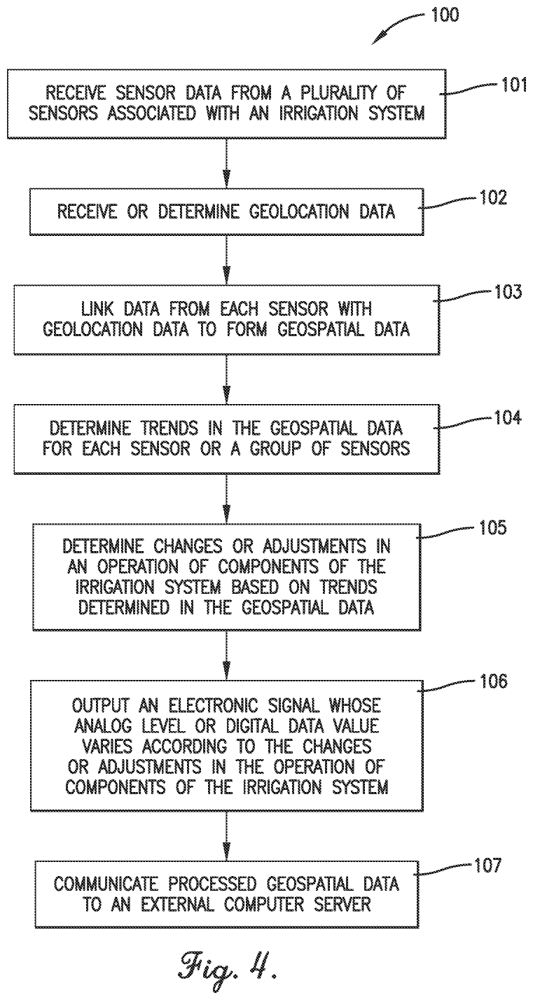

FIG. 4 depicts a listing of at least a portion of the steps of an exemplary method 100 for processing geospatial data associated with an irrigation system 12. The steps may be performed in the order shown in FIG. 4, or they may be performed in a different order. Furthermore, some steps may be performed concurrently as opposed to sequentially. In addition, some steps may be optional or may not be performed. The steps of the method 100 may be performed by the processing element 44 of the computing device 10 and/or components of the irrigation system 12.

Referring to step 101, sensor data is received from a plurality of sensors 16. The sensors 16 generally sense or detect performance quantities and/or operating parameters of various components of the irrigation system 12. For example, sensors, including potentiometers, rotary encoders, analog proximity sensors, analog laser proximity sensors, analog ultrasonic proximity sensors, or combinations thereof, may measure a rotational angle between two adjacent mobile towers 30 or sections of the conduit 26. Water gauges, including flow meters and the like, may measure the amount of water that has been applied to the crops during a certain time period. Pressure gauges may measure the water pressure at one or more points throughout the irrigation system 12. Tire pressure sensors may sense a plurality of pressures, one pressure associated with each tire utilized in the mobile towers 30 of the irrigation system 12. Electrical sensors, or electronic sensing circuitry, may sense a plurality of electric voltages and/or electric currents, one voltage and/or current associated with each drive motor 36 of the irrigation system 12. A gearbox sensor monitors or senses a status of the gearbox coupled to the drive motor 36. The gearbox sensor may include a plurality of sensors such as a temperature sensor, a pressure sensor, a viscosity sensor, a torque sensor, or any other suitable sensor. Sensors placed on the ground or elsewhere may sense or detect water that reaches the crops 14 in order to determine water application efficiency, or the water loss between the sprayers and the crops.

The sensors 16 may also sense or detect environmental quantities or conditions. For example, sensors may detect temperature, humidity, wind speed, air pressure, rain fall, available water, and the like. Alternatively, the computing device 10 may receive these values electronically from local atmospheric monitoring stations.

The sensors 16 may further include cameras capable of capturing images in the visible range, the near infrared range, the thermal infrared range, the short wave infrared range, and the like. Alternatively, the computing device 10 may receive these images electronically from satellite or other image capturing stations.

In addition, the sensors 16 may be able to determine topography or elevation of the land being irrigated as the irrigation system 12 moves across the land. Alternatively, the computing device 10 may receive topography or elevation data electronically from external sources.

Furthermore, the sensors 16 may be able to sense or determine a type of crops 14 that are being irrigated. Alternatively, the computing device 10 may receive crop information from a land manager, a farmer, or other external sources.

Referring to step 102, geolocation data is received or determined. The sensors 16 may include a location determining element configured to determine a current geolocation of one or more mobile towers 30 or components of the irrigation system 12. Alternatively, or additionally, the processing element 44 may perform calculations to determine geolocation data. For example, the processing element 44 may receive sensor information about the rotation angle between two or more mobile towers 30. The processing element 44 may then perform trigonometric or other mathematical calculations to determine the geolocation of each mobile tower 30. Or, the processing element 44 may perform dead reckoning calculations, which involve receiving measured distances traveled by each mobile tower 30 or other component, to determine the geolocation of each mobile tower 30 or other components.

Geotechnical data is also received. The geotechnical data may include soil materials or composition, geological formations including rock or mineral deposits, elevational information identifying plains or hills, water features including rivers, streams, or ponds, and the like. All of the geotechnical data may already be linked or associated with geolocation data.

Referring to step 103, data from each sensor 16 is linked with geolocation data to form geospatial data. The processing element 44 associates, correlates, or links the geolocation data to the input data. In one scenario, the processing element 44 may receive sensor data as a series of sampled data points from each sensor 16 while at the same time, or nearly the same time, the processing element 44 may receive, or calculate, geolocation data for the particular sensor 16. For example, the processing element 44 may receive water pressure data as a series of sampled data points from a water pressure sensor at a particular mobile tower 30, while at the same time, or nearly the same time, the processing element 44 may receive geolocation data from a location determining sensor at the particular mobile tower 30. The processing element 44 then links the water pressure reading with the geolocation data and optionally a timestamp (time of day, date) as well. The linked input (sensor) data and geolocation data, along with optional timestamp data, is one piece of geospatial data. The processing element 44 may utilize the geospatial data interchange format based on JavaScript Object Notation (GeoJSON).

The processing element 44 may also link the geotechnical data with sensor data to form geospatial data. Thus, sensor data is linked with geolocation data, such as a latitude and longitude point, line, or area, and geotechnical data, such as soil composition and/or elevation. In some embodiments, the method 100 may proceed from step 103 to step 107. In other embodiments, the method 100 may proceed from step 103 to step 104.

Referring to step 104, trends in the geospatial data for each sensor 16 or a group of sensors 16 are determined. The processing element 44 continues to receive both input data, such as sensor data, and geolocation data as time passes and the mobile towers 30 move over the land to be irrigated. The processing element 44 also continues to link the input data and geolocation data to create geospatial data. After a certain minimum amount of data has been collected, the processing element 44 analyzes the geospatial data to determine trends, patterns, and/or anomalies in the geospatial data. In some embodiments, the processing element 44 analyzes the geospatial data to determine trends, patterns, and/or anomalies after one cycle of irrigation has occurred, wherein one cycle includes one full rotation of the conduit 26 in a circular, or near circular, central pivot irrigation system 12. One cycle of irrigation may include a full pass of the conduit 26 to cover the area of a linear or lateral irrigation system 12.

The analysis may include determining increases and/or decreases in the data from each sensor 16 or group of sensors 16. The increases and/or decreases may occur over distance, area, or space and/or over time. The analysis may also include determining, computing, or calculating statistics, such as a mean or average, a moving or windowed mean or average, a median, a standard deviation, and the like, for the data from each sensor 16 or group of sensors 16. The processing element 44 may also determine when an average for a sensor 16 or group of sensors 16 is changing or if the data for a sensor 16 or group of sensors 16 has values outside of the standard deviation of the data for the sensor 16 or group of sensors 16. For example, the processing element 44 may analyze the data from one or more sensors 16 that measure water pressure in the conduit 26 or other components of the irrigation system 12. The processing element 44 may determine when the water pressure has changes, such as steady or sharp decreases or increases.

In addition, the processing element 44 determines geospatial intersections, i.e., relationships between the trends in the sensor data with geolocation data and/or geotechnical data. When the processing element 44 determines or detects a change in the data for each sensor 16 or group of sensors 16, the processing element 44 also determines if the change in sensor data has a relationship, such as a correlation, with the geolocation data. For example, the processing element 44 may determine if the data for each sensor 16 or group of sensors 16 repeatedly changes in the same geolocation, such as a point or, more likely, an area of the land that is being irrigated. In one instance, the processing element 44 may determine an increase in drive motor electric current every time one or more mobile towers 30 are in a particular geolocation. This scenario may be indicative of a rut or gulley in the ground that the drive motors 36 of the mobile towers 30 have to work harder to get out of.

The processing element 44 may further analyze geotechnical data to determine relationships between the trends in the sensor data with geotechnical data or geological features. For example, the processing element 44 may determine if the data for a sensor 16 or group of sensors 16 repeatedly changes at certain elevations or changes in elevations. In one instance, the processing element 44 may determine a correlation between a repeated decrease in water pressure in the conduit 26 or other components and an increase in elevation, resulting from the mobile towers 30 moving up a hill. The processing element 44 may also determine if the data for a sensor 16 or group of sensors 16 repeatedly changes for certain types of soil composition. In another instance, the processing element 44 may determine a correlation between a repeated decrease in moisture level from ground sensors and the times when the mobile towers 30 travel over ground that has a dry or rocky soil composition.

The processing element 44 utilizes artificial intelligence and/or machine learning techniques or components to analyze the geospatial data to determine trends, patterns, and/or anomalies in the geospatial data. The geospatial data, including the sensor data and its linked geolocation data, is communicated to artificial intelligence and/or machine learning hardware units or software modules which analyze the geospatial data and identify trends or patterns in the geospatial data that indicate adjustments or changes to the operation of the irrigation system 12. The processing element 44 may utilize predictive analytics, artificial neural networks, convolutional neural networks, decision trees, or the like, or combinations thereof.

Referring to step 105, changes or adjustments in an operation of components of the irrigation system based on trends determined in the geospatial data are determined. The processing element 44 also determines actions to take based on the determined trends, patterns, and/or anomalies in the geospatial data. The processing element 44 adjusts or changes the operation of components of the irrigation system 12. For example, based on the determination of a decrease in water pressure in the conduit 26 when the mobile towers 30 move up a hill, the processing element 44 may determine to increase the water pressure in the conduit 26 whenever the mobile towers 30 move to the geolocation area associated with the hill. As another example, based on the determination of a decrease in moisture level in dry or rocky soil, the processing element 44 may determine to slow down the mobile towers 30 whenever the mobile towers 30 pass through the geolocation area with the dry or rocky soil. Additionally or alternatively, the processing element 44 may determine to open additional valves 32 or otherwise increase water output whenever the mobile towers 30 pass through the geolocation area with the dry or rocky soil.

Referring to step 106, an electronic signal whose analog level or digital data value varies according to the changes or adjustments in the operation of components of the irrigation system is output. Referring to FIG. 3, the processing element 44 outputs an electronic signal, such as an analog electric voltage or electric current and/or digital data. The electronic signal may include a variable level analog electric voltage or electric current or a serial stream of variable value digital data. The electronic signal is received by the system controller 38 and includes information necessary to control the operation of the components of the irrigation system 12. The system controller 38 may output a plurality of electronic signals, each electronic signal having an analog electric voltage or electric current level and/or digital data value. Each electronic signal is received by one or more of the electrically-controlled components of the irrigation system 12 such as the drive motors 36, the valves 32, and the pumps 34.

In embodiments in which the computing device 10 and the system controller 38 function as a single unit, the processing element 44 outputs a plurality of electronic signals, each electronic signal having an analog electric voltage or electric current level and/or digital data value. Each electronic signal is received by one or more of the electrically-controlled components of the irrigation system 12 such as the drive motors 36, the valves 32, and the pumps 34.

The processing element 44 outputs the electronic signal whose analog level or digital data value varies according to changes or adjustments that need to be made in the operation of various components based on the determined trends, patterns, and/or anomalies in the geospatial data. For example, the processing element 44 outputs the electronic signal to be received by the pumps 34, either directly or through the system controller 38, wherein the analog level or digital data value of the electronic signal instructs the pumps 34 to increase the water pressure to the conduit 26 or other components when the processing element 44 determines that the mobile towers 30 are moving up a slope.

Referring to step 107, processed geospatial data is communicated to an external computer server 20. The processing element 44 also communicates data, including processed geospatial data, to the computer server 20 through the communication network 18. The processing element 44 may report any trends discovered in the geospatial data as well as any changes or adjustments to the operation of the components of the irrigation system 12.

The computing device 10 may further provide the following additional services, wherein the processing element 44 is further configured and/or programmed, via hardware, software, firmware, or combinations thereof, to perform the following operations and functions.

The processing element 44 receives data, measured from sensors 16 and/or received from other sources, regarding a quantity, such as volume, of water or other fluid that has been applied to the soil corresponding to geospatial data. The processing element 44 may determine a volume of water, or trends in the volume of water, that has been applied to one or more geolocations for a given period of time. The processing element 44 may also determine, retrieve from the memory element 42, or retrieve from an external source, an optimal volume of water that should be applied to the geolocations for the period of time. The processing element 44 may compare measured data values of applied water volume, or trends in the measured data values of applied water volume, with optimal values of applied water volume. Based on, or according to, differences between the measured data, or trends in the measured data, and the optimal values, the processing element 44 may adjust the application rate of water in order to reduce the differences. The processing element 44 may adjust the application rate of water by adjusting the flow of water through the conduit 26 and/or sprayers or may adjust the speed of travel of the mobile towers 30. For example, if the processing element 44, based on measured data, or trends in the measured data, determines that too little water has been applied, the processing element 44 may increase the amount of water that flows through the conduit 26 and/or sprayers by adjusting the operations of the valves 32 and/or the pumps 34. The processing element 44 may also decrease the speed of travel of the mobile towers 30 by adjusting the operation of the appropriate drive motors 36. Alternatively, if the processing element 44 determines that too much water has been applied, the processing element 44 may decrease the amount of water that flows through the conduit 26 and/or sprayers by adjusting the operations of the valves 32 and/or the pumps 34. The processing element 44 may also increase the speed of travel of the mobile towers 30 by adjusting the operation of the appropriate drive motors 36. In any case, the processing element 44 may further adjust irrigation (water flow) start and stop times to increase or decrease the volume of water applied. The processing element 44 adjusts the operation of the valves 32, the pumps 34, and the drive motors 36 by adjusting data values, electric voltage and/or current levels, pulse width modulation values, or the like, or combinations thereof of electronic signals which are output to the components. In addition, the processing element 44 may adjust the operation of the components according to geospatial data, wherein adjustments may be made in some geolocations but not others, or different adjustments may be made in different geolocations.

The processing element 44 receives data, measured from sensors 16 and/or received from other sources, regarding a pressure of the water or fluid in the irrigation system 12, such as in the conduit 26 and/or the sprayers, corresponding to geospatial data. That is, the processing element 44 may determine the pressure of the water, or trends in the pressure of the water, in the irrigation system 12 for one or more geolocations for a given period of time. The processing element 44 may also determine, retrieve from the memory element 42, or retrieve from an external source, an optimal pressure of the water in the irrigation system 12 for the geolocations for the period of time. The processing element 44 may compare measured data values of irrigation system 12 water pressure, or trends in the measured data values of irrigation system 12 water pressure, with optimal values of irrigation system 12 water pressure. Based on, or according to, differences between the measured data, or trends in the measured data, and the optimal values, the processing element 44 may adjust the application rate of water in order to reduce the differences. The pressure of the water in the irrigation system 12 affects the application rate of the water in a direct manner. Typically, a lower than optimal water pressure results in a lower application rate, or underwatering, while a higher than optimal water pressure results in a higher application rate, or overwatering. The processing element 44 may adjust the application rate of water by adjusting the speed of travel of the mobile towers 30 or may adjust the flow of water through the conduit 26 and/or sprayers. For example, if the processing element 44, based on measured data, or trends in the measured data, determines that the pressure of the water in the irrigation system 12 is below a first threshold, then the processing element 44 may decrease the speed of travel of the mobile towers 30 by adjusting the operation of the appropriate drive motors 36 to compensate for low water pressure. In addition, or instead, the processing element 44 may adjust the flow rate of the pumps 34 and/or change the settings of the valves 32 to increase the pressure of the water in the irrigation system 12. If the processing element 44 determines that the pressure of the water in the irrigation system 12 is above a second threshold, then the processing element 44 may increase the speed of travel of the mobile towers 30 by adjusting the operation of the appropriate drive motors 36 to compensate for high water pressure. The processing element 44 may also or alternatively adjust the flow rate of the pumps 34 and/or change the settings of the valves 32 to decrease the pressure of the water in the irrigation system 12. In any case, the processing element 44 may further adjust irrigation start and stop times to compensate for water pressure that is not within normal parameters. The processing element 44 may adjust the operation of the components according to geospatial data, wherein adjustments may be made in some geolocations but not others, or different adjustments may be made in different geolocations.

The processing element 44 receives data, measured from sensors 16 and/or received from other sources, regarding an alignment of the towers 30 corresponding to geospatial data, wherein the alignment refers to the angular relationship between two or more adjacent towers 30 relative to one another or one or more towers relative to the center pivot 22. For example, as shown in FIG. 1, the third mobile tower has a roughly zero-degree alignment angle with the second mobile tower 30B, which, in turn, has a roughly zero-degree alignment angle with the first mobile tower 30A. Any one of the towers 30 may have an angular alignment with the central pivot 22 that is determined by a geographic direction, an azimuth, or other angular relational or directional system. The processing element 44 may determine the alignment between two or more of the towers 30, or trends in the alignment, for one or more geolocations for a given period of time. The processing element 44 may also determine one or more geolocations where alignment errors, or misalignment, have occurred in the past, wherein an alignment error or misalignment may include the alignment angle between any two of the towers 30 being greater than an alignment threshold value. In addition, the processing element 44 may determine a prediction, or a forecast, of one or more geolocations where alignment errors, or misalignment, are likely to occur in the future. The processing element 44 may increase or decrease the speed of travel of the mobile towers 30 by adjusting the operation of the appropriate drive motors 36 to proactively correct or prevent misalignment of one or more towers 30 in geolocations where issues have occurred or are predicted to occur based on the trending data. In addition, or instead, the processing element 44 may increase or decrease the amount of time that each drive motor 36 operates or may adjust the alignment angle at which each drive motor 36 engages in order to proactively correct or prevent misalignment of one or more towers 30 in one or more geolocations. For example, the processing element 44 may operate the appropriate drive motors 36 to adjust the alignment angle between any one or more adjacent pairs of towers 30 to be roughly equal to zero degrees or any other fixed alignment angle value, such that the towers 30 are in a safe alignment configuration.

The processing element 44 receives data, measured from sensors 16 and/or received from other sources, regarding a pressure of the tires of the towers 30 corresponding to geospatial data. The processing element 44 may determine trends in the pressure, such as decreasing pressure, of the tires of the towers 30 in the irrigation system 12. The processing element 44 may adjust the position of one or more towers or the irrigation system 12 as a whole, according to the pressure, or trends in the pressure, of any of the tires of the towers 30. For example, if the pressure of one or more tires is less than a certain threshold, or if the trend of the pressure of one or more tires indicates a steady or rapid decrease, then the processing element 44 may position one or more towers 30 associated with the one or more low pressure tires in an area where access is good and service is easy to perform. In some instances, the processing element 44 may move the irrigation system 12 to the vicinity of a service road for ease of maintenance or repair. The processing element 44 may move the towers 30 and/or position the irrigation system 12 by controlling the operation of the drive motors 36.

The processing element 44 receives data, measured from sensors 16 and/or received from other sources, regarding electrical characteristics, such as electric current flow, of the drive motors 36 corresponding to geospatial data. The processing element 44 may determine trends in the electrical characteristic data, such as increasing electric current flow. The processing element 44 may adjust the position of one or more towers 30, or the irrigation system 12 as a whole, according to the electrical characteristic data, or trends in the electrical characteristic data, for any of the drive motors 36. An unexpected increase in electric current flow should be investigated. Thus, if the electric current flow through any one of the drive motors 36 exceeds a certain threshold, or if the trend of the electric current flow through any one of the drive motors 36 indicates a steady or rapid increase, then the processing element 44 may position one or more towers 30 associated with the problematic drive motor 36 in an area where access is good and service is easy to perform. The processing element 44 may also issue an electrical shutdown of the irrigation system 12.

The processing element 44 receives data, measured from sensors 16 and/or received from other sources, regarding water application efficiency of the irrigation system 12 corresponding to geospatial data. The water application efficiency relates to an amount of water that reaches the crops 14 versus an amount of water that is provided by the irrigation system 12 and may be determined or calculated as the volume of water received by the crops 14 divided by the volume of water delivered by the irrigation system 12. The processing element 44 may determine trends in the water application efficiency data for one or more geolocations for a given period of time. The processing element 44 may also determine, retrieve from the memory element 42, or retrieve from an external source, an optimal water application efficiency for the geolocations for the period of time. The processing element 44 may compare determined values of water application efficiency, or trends in the determined values of water application efficiency, with optimal values of water application efficiency. Based on, or according to, differences between the determined values, or trends in the determined values, and the optimal values, the processing element 44 may adjust the application rate of water in order to reduce the differences. Typically, the processing element 44 detects when the determined water application efficiency is less than optimal by greater than a certain amount. For example, if the optimal water application efficiency minus the determined water application efficiency is greater than a certain threshold for one or more geolocations, then the processing element 44 may decrease the speed of travel of the mobile towers 30 by adjusting the operation of the appropriate drive motors 36 at those geolocations. In addition, or instead, the processing element 44 may increase the amount of water that flows through the conduit 26 and/or sprayers by adjusting the operations of the valves 32 and/or the pumps 34 at those geolocations. In any case, the processing element 44 may further adjust irrigation start and stop times to increase water application efficiency.

The processing element 44 receives a plurality of images from video sensors 16, such as cameras, or from external sources. The images may be captured in one or more of the following formats: near infrared (NIR), short-wave infrared (SWIR), red-green-blue (RGB), thermal, or the like. In addition, or instead, the processing element 44 may receive a plurality of derived images with formats such as enhanced vegetation index (EVI) or normalized difference vegetation index (NDVI). The images and derived images may provide visual indications or evidence of vegetation growth and health. The images and derived images may be of one or more crops, may cover one or more geolocations, and may be received periodically over a period of time. For example, the images and derived images may be of one crop that is planted in one or more geolocations or one or more crops planted in a plurality of geolocations. The images and derived images may be received at a rate of one image per hour, per day, per week, or the like for each geolocation over an extended period of time, such as a year. Using AI and/or other image analysis techniques, the processing element 44 may determine changes, trends, or anomalies in the images and derived images over time for each geolocation, wherein the changes may indicate crop 14 growth and health. In some embodiments, the processing element 44 may determine changes, trends, or anomalies in the images and derived images over time by comparing the content of current images to the content of historical images. The processing element 44 makes adjustments to the operation of the irrigation system 12 according to the changes, trends, or anomalies in the images and derived images. If the changes, trends, or anomalies in the images and derived images indicate that a crop 14 is water stressed in one or more geolocations, then the processing element 44 may decrease the speed of travel of the mobile towers 30 by adjusting the operation of the appropriate drive motors 36 at those geolocations. In addition, or instead, the processing element 44 may increase the amount of water that flows through the conduit 26 and/or sprayers by adjusting the operations of the valves 32 and/or the pumps 34 at those geolocations. If the changes, trends, or anomalies in the images and derived images indicate that a crop 14 is water stressed in one or more geolocations while the irrigation system 12 is not operating, i.e., spraying water, then the processing element 44 starts operation of the irrigation system 12. In addition, the processing element 44 may determine changes, trends, or anomalies in the images and derived images over time for each geolocation in order to determine an amount of water that should be applied to the geolocations. For example, changes, trends, or anomalies in the images and derived images over time that indicate slow growth and/or poor health for one or more geolocations may require additional water to be applied. Thus, the processing element 44 may decrease the speed of travel of the mobile towers 30 by adjusting the operation of the appropriate drive motors 36 at those geolocations. In addition, or instead, the processing element 44 may increase the amount of water that flows through the conduit 26 and/or sprayers by adjusting the operations of the valves 32 and/or the pumps 34 at those geolocations. On the other hand, changes, trends, or anomalies in the images and derived images over time that indicate sufficient growth and/or good health for one or more geolocations may require nominal water or less water to be applied. In those areas, the processing element 44 may make no change, or may adjust the operation of the appropriate drive motors 36, the valves 32, the pumps 34, or combinations thereof, to decrease the amount of water applied. In any case, the processing element 44 may further adjust irrigation start and stop times to increase or decrease water application, as appropriate.

The processing element 44 receives data, measured from sensors 16 and/or received from other sources, regarding an elevation or topography of the land in which the crops 14 to irrigated are planted corresponding to geospatial data. The elevation of the land relates to increases and decreases of elevation, such as hills and valleys. Furthermore, the geospatial data links or associates the elevational data with geolocation data such that, for a plurality of geolocations within the area in which crops 14 are planted, the elevation of the land is known. The processing element 44 determines trends in the data system wide corresponding to the geospatial data. That is, the processing element 44 determines changes in the volume of water applied, the water application efficiency, the pressure of the water in the irrigation system 12, the electrical characteristics of the drive motors, the speed of the towers 30, the alignment of the towers and the air pressure of the tires, among others, corresponding to the geospatial data. In particular, the processing element 44 may determine changes in any of the listed parameters, and others, that correspond to changes in elevation. Furthermore, the processing element 44 may determine whether the changes in any of the listed parameters affect the successful operation of the irrigation system 12, such as any of parameters falling below a critical threshold in relation to changes in elevation. Thus, the processing element 44 may adjust the operational parameters according to geospatial data, specifically, elevational data. For example, based on geolocation data, the processing element 44 may determine that a change in elevation is imminent if the towers continue on their current trajectory. In anticipation, the processing element 44 may proactively increase or decrease the speed of the towers 30, increase or decrease the pressure of the water in the irrigation system 12, adjust the alignment of the towers 30, adjust irrigation start and stop times, and the like, in order to maintain operational parameters within acceptable levels as the irrigation system 12 approaches and passes through changes in elevation.

The processing element 44 receives data, measured from sensors 16, derived from environmental models, derived from images (such as those described above), or combinations thereof, regarding moisture or water that is within the soil and available to the crop 14. The processing element 44 may determine trends in the soil moisture data for one or more geolocations for a given period of time. The processing element 44 may adjust the application of water according to moisture levels in the soil. For example, if the processing element 44 determines the soil moisture level is low, or the trend in the soil moisture level is declining, for one or more geolocations, then the processing element 44 may increase the water application by increasing the amount of water that flows through the conduit 26 and/or sprayers and/or slowing down the towers 30 in the geolocations. If the processing element 44 determines the soil moisture level is high, or the trend in the soil moisture level is increasing, for one or more geolocations, then the processing element 44 may decrease the water application by decreasing the amount of water that flows through the conduit 26 and/or sprayers and/or speeding up the towers 30 in the geolocations. In any case, the processing element 44 may further adjust irrigation start and stop times to increase or decrease the volume of water applied. A variable rate irrigation (VRI) plan may be implemented to provide proper water application according to soil moisture levels in a plurality of geolocations.

The processing element 44 receives data, measured from sensors 16, derived from environmental models, derived from images (such as those described above), or combinations thereof, regarding an amount of rain that has fallen over a recent period of time for one or more geolocations. The processing element 44 may adjust the application of water according to the amount of rain fall, such as in units of inches or millimeters, that has occurred in one or more geolocations. For example, if the processing element 44 determines that rain has recently fallen in one or more geolocations, then the processing element 44 may decrease the application of water in the geolocations by decreasing the amount of water that flows through the conduit 26 and/or sprayers and/or speeding up the towers 30. The amount of water applied may vary according to the amount of rain that has fallen, wherein, generally, a larger amount of rainfall results in a smaller amount of water applied by the irrigation system 12 and a smaller amount of rainfall results in a larger amount of water applied. If the processing element 44 determines that rain has not fallen recently in one or more geolocations, then the processing element 44 may increase the application of water in the geolocations by increasing the amount of water that flows through the conduit 26 and/or sprayers and/or slowing down the towers 30. In any case, the processing element 44 may further adjust irrigation start and stop times to increase or decrease water application, as appropriate.

The processing element 44 receives data, measured from sensors 16, derived from environmental models, derived from images (such as those described above), or combinations thereof, regarding crops that are growing in one or more geolocations. The data may include crop type, growth stage, planting date, plant variety, and so forth. The processing element 44 may adjust the application of water according to the crop data in one or more geolocations. For example, one type of crop may generally require more water than another type of crop, and thus, water application is adjusted accordingly. Crops at an early growth stage, or having a more recent plant date, may require more water than those at a later growth stage, or having a less recent plant date. Water application is adjusted accordingly. Water application may be adjusted accordingly for other crop data as well.

### ADDITIONAL CONSIDERATIONS

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A computing device for processing geospatial data associated with an irrigation system, the computing device comprising:
a processing element in electronic communication with a memory element, the
processing element configured or programmed to
receive sensor data over time from one or more sensors associated with the irrigation system, the sensors configured to output data corresponding to a fluid pressure within the irrigation system,
receive or determine geospatial data regarding fluid pressure within the irrigation system over a plurality of geolocations, and
output a varying electronic signal to adjust a speed of one or more towers of the irrigation system, the electronic signal varying according to the geospatial data regarding fluid pressure within the irrigation system.

2. The computing device of claim 1, wherein the processing element is further configured or programmed to output the electronic signal to decrease the speed of one or more towers in geolocations where the fluid pressure within the irrigation system is below a first threshold.

3. The computing device of claim 1, wherein the processing element is further configured or programmed to output the electronic signal to increase the speed of one or more towers in geolocations where the fluid pressure within the irrigation system is above a second threshold.

4. The computing device of claim 1, wherein the electronic signal output by the processing element is received by one or more drive motors, each drive motor configured to propel one of the towers.

5. A computing device for processing geospatial data associated with an irrigation system, the computing device comprising:
a processing element in electronic communication with a memory element, the
processing element configured or programmed to
receive or determine geospatial data regarding water application efficiency derived from efficiency data corresponding to a volume of water delivered by the irrigation system and a volume of water received by one or more crops over a plurality of geolocations, and
output a varying electronic signal to at least one of a plurality of drive motors, a plurality of valves, or a plurality of pumps to adjust an amount of fluid delivered by the irrigation system, the electronic signal varying according to the geospatial data regarding water application efficiency.

6. The computing device of claim 5, wherein the processing element is further configured or programmed to
determine a difference between the received or determined geospatial data regarding water application efficiency and optimal values of geospatial data regarding water application efficiency, and
output the electronic signal to one or more drive motors to decrease the speed of one or more towers in geolocations where the difference is above a threshold.

7. The computing device of claim 5, wherein the processing element is further configured or programmed to
determine a difference between the received or determined geospatial data regarding water application efficiency and optimal values of geospatial data regarding water application efficiency, and
output the electronic signal to at least one of the valves to increase an amount of fluid delivered by the irrigation system in geolocations where the difference is above a threshold.

8. A computing device for processing geospatial data associated with an irrigation system, the computing device comprising:
a processing element in electronic communication with a memory element, the processing element configured or programmed to
receive sensor data over time from one or more sensors associated with the irrigation system, the sensors configured to output data corresponding to an alignment angle between two or more adjacent towers of the irrigation system,
receive or determine geospatial data regarding the alignment angle between two or more adjacent towers of the irrigation system over a plurality of geolocations, and
output a varying electronic signal to adjust the alignment angle between two or more adjacent towers of the irrigation system, the electronic signal varying according to the geospatial data regarding the alignment angle between two or more adjacent towers of the irrigation system.

9. The computing device of claim 8, wherein the electronic signal output by the processing element is received by one or more drive motors, each drive motor configured to propel one of the towers.

10. The computing device of claim 9, wherein the electronic signal output by the processing element adjusts a speed of the one or more drive motors.

11. The computing device of claim 9, wherein the electronic signal output by the processing element adjusts an amount of time of operation of the one or more drive motors.

12. The computing device of claim 9, wherein the electronic signal output by the processing element adjusts the alignment angle between two adjacent towers of the irrigation system to roughly zero degrees.

13. The computing device of claim 1, wherein the processing element is further configured or programmed to, instead of output the varying electronic signal to adjust the speed of one or more towers of the irrigation system, output the varying electronic signal to adjust a flow rate of a plurality of pumps that maintain the fluid pressure within the irrigation system.

14. The computing device of claim 13, wherein the processing element is further configured or programmed to output the electronic signal to adjust the pumps to increase the fluid pressure in geolocations where the fluid pressure within the irrigation system is below a first threshold.

15. The computing device of claim 13, wherein the processing element is further configured or programmed to output the electronic signal to adjust the pumps to decrease the fluid pressure in geolocations where the fluid pressure within the irrigation system is above a second threshold.

16. The computing device of claim 5, wherein the processing element is further configured or programmed to
determine a difference between the received or determined geospatial data regarding water application efficiency and optimal values of geospatial data regarding water application efficiency, and
output the electronic signal to at least one of the pumps to increase an amount of fluid delivered by the irrigation system in geolocations where the difference is above a threshold.

17. The computing device of claim 8, wherein the processing element is further configured or programmed to output the electronic signal to adjust the alignment angle between two or more adjacent towers of the irrigation system in geolocations where misalignment is likely to occur.
